(19) United States
(12) Patent Application Publication
(10) Pub. No.: US 2013/0151382 A1
(43) Pub. Date: Jun. 13, 2013

(54) System and method for modeling articles of clothing

(71) Applicant: Andrew S. Fuller, Odessa, FL (US)

(72) Inventor: Andrew S. Fuller, Odessa, FL (US)

(21) Appl. No.: 13/593,803

(22) Filed: Aug. 24, 2012

Related U.S. Application Data
(60) Provisional application No. 61/568,703, filed on Dec. 9, 2011.

(51) Int. Cl. G06Q 30/00

(52) U.S. Cl. 705/27.2

(57) ABSTRACT

A system and method for modeling articles of clothing includes a database having representation of an article of clothing and associated movement parameters characterizing motion flow of the article of clothing on a person in motion, and an image generator configured to generate a representative image of a person in motion. The movement parameters for the article of clothing are used to manipulate a representation of the article of clothing on a representation of the person in motion using the movement parameters for the article of clothing, thereby simulating the person in motion wearing the article of clothing.

### CROSS REFERENCE TO RELATED APPLICATIONS

This application claims the benefit of Provisional Application Ser. No. 61/568,703 entitled “System and Method for Managing Modeling of an Article of Clothing”, filed Dec. 9, 2011, which is herein incorporated by reference in its entirety.

### BACKGROUND

Online shopping has exploded in popularity over the recent years., and now compete with brick and mortar shopping in many categories., including articles of clothing. However, the purchase of articles of clothing online can pose quite challenging for shoppers, as there is no easy way to assure a proper fit, based in part on the variety of styles and body and wear characteristics of each individual. Most people select clothing based on standard size designators, such as small, medium, large, extra large, and the like, or a numeric based system representing standard sizes, or a combination of numbers for areas of a person commonly measured. Such a system relies on manufacturers correctly marking clothing based on the standard sizes. However, it is well known that the so-called standard sizes may vary among manufacturers, and in any case, and that the fit may vary dramatically depending on style. Consequently, clothing that looks fabulous on a model, or on another person, may not suitably fit a particular target individual. In local physical stores, a purchaser may be given the option of trying on clothing to determine proper fit, prior to purchasing. For online shopping, this option does not exist, and an improper fit may result in a dissatisfied customer, or extra costs involved with returns. There exists a need for a solution for efficiently shopping online for articles of clothing, which greatly enhances a successful fit for an individual. An improved solution can also help in physical stores to avoid restocking and other costs for clothes that do not fit. There is also a need for a new shopping model compatible with new forms of online interaction, such as through social media.

### BRIEF DESCRIPTION OF THE DRAWINGS

FIG. 1 is a representation of a system for managing the modeling of articles of clothing, in accordance with the present invention.

FIG. 2 is a representation of a system for capturing movement parameters for an article of clothing, in accordance with of present invention.

FIG. 3 is a flowchart of procedures for the capturing of movement parameters for an article of clothing, in accordance with the present invention.

### DETAILED DESCRIPTION OF THE PREFERRED EMBODIMENT

According to the present invention, online shopping and other web or internet based interaction is facilitated by a system that obtains modeling parameters for an article of clothing, which includes motion parameters specific to the article of clothing, and generates a representation of a person wearing or modeling the article of clothing by manipulating a representation of the article of clothing on a representation of the person in motion, using the motion parameters for the article of clothing. The system may also obtain size and dimension parameters for the article of clothing as well as size and dimension parameters for the person. In one embodiment, the motion parameters for the article of clothing are derived based in part on the size parameters for the article of clothing and the size parameters for the person.

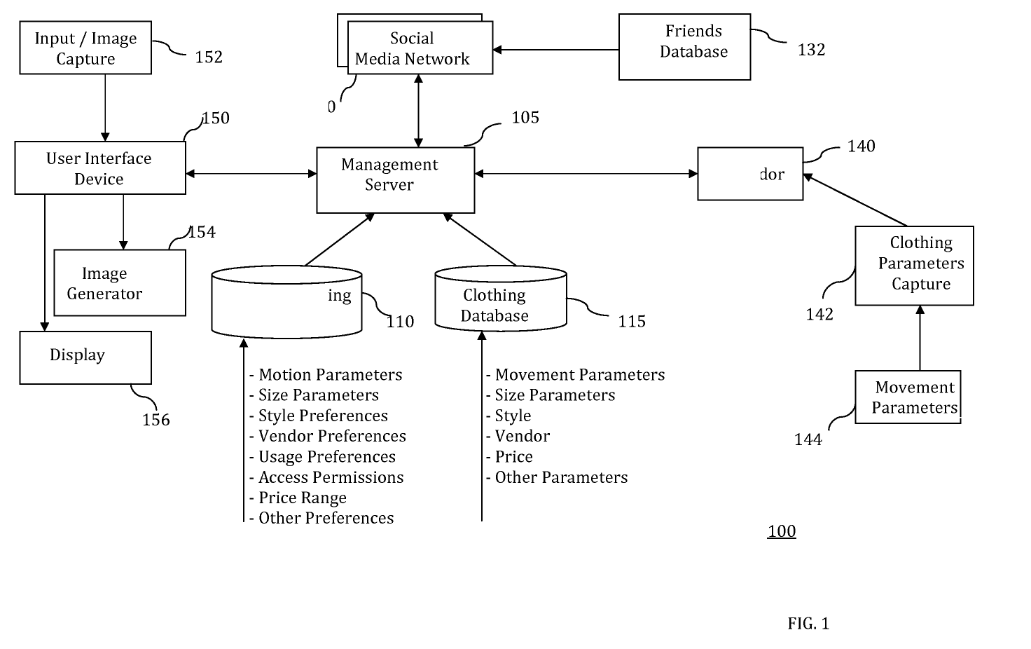

Referring to FIG. 1, a networked system 100 is shown for managing the modeling of articles of clothing, in accordance with the present invention. The system 100 can be implemented on a localized device, such as a desktop or laptop computer, gaming console, or other computational device. Alternatively, the system can be implemented on a sophisticated network of computers and storage device, with functionality distributed among the devices. The system preferably includes a management server 105 that interfaces with a database that houses modeling parameters related to individuals or persons, and modeling parameters related to articles of clothing. The server 105 is a computer-based system that interfaces to local storage or networked storage devices 115, 110, and that executes a set of instructions to store, retrieve, and manipulate parameters related to articles of clothing and to individuals or persons. In the preferred embodiment, storage device 110 contains a database of modeling parameters for a person. These modeling parameters include motion parameters and size parameters that can be used to build a physical profile representation of the person. The database further contains other information such as style, vendor, and designer preferences, and preferred price ranges, and other preferences which can be used to build a shopping or best-match clothing profile for a person. Additionally, privacy, usage, and permissions information governing permitted uses for the information pertaining to a person are included. Storage device 115 contains a database of modeling parameters for an article of clothing. The clothing modeling parameters include movement parameters, and size parameters, which will be further described below. The clothes modeling database also contains information on vendors or clothing sources and styles, as well as other information related to shopping, such as price and availability.

In the preferred embodiment, the management server interfaces with a social media system 130, a vendor system 140, and a user interface system 150. The social media system is used as a repository for storing/sharing of profile data constructed from the modeling parameters for a person and modeling parameters for an article of clothing, and/or as an information source, such as a friends database 132 to facilitate authorized access to the modeling parameters. The vendor system 140 preferably has access to a system 142 for capturing modeling parameters for articles of clothing, including movement parameters for such articles of clothing. The user interface system 150 leverages a sub-system, including an input/image capture device 152, an image generator 154, and a display system 156 for capturing a person's modeling parameters, for generating images and for displaying them to a user. The user interface system 150 is coupled to the management server 105 and the associated databases 110, 115, which access to a clothing profile for a person, including preferences for fit and wear characteristics for clothing. The input capture device 152 is used for selecting an article of clothing, such as during a virtual shopping session. The image generator 154 is configured to generate a representative image of a person in motion, and for manipulating the representative image of the person in motion using the movement parameters for the article of clothing such as to create an appearance to an observer that the person in motion is wearing the article of clothing. The display system 156 is configured to display the representation image of the person in motion wearing the article of clothing based on selection of the article of clothing.

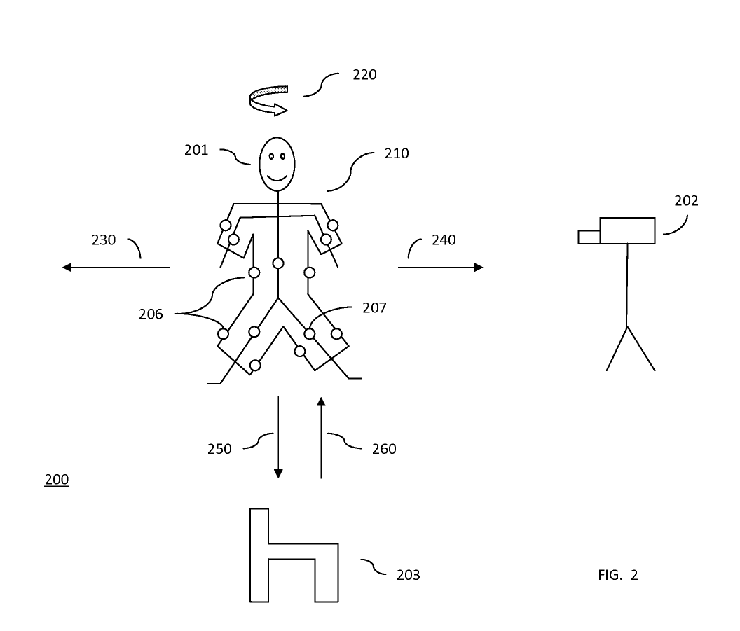

FIG. 2 illustrates a system 200 to capture modeling parameters for an article of clothing, in accordance with the present invention. In this example, a person 201 is outfitted with an article of clothing 205 for which movement parameters are desired. The person is further fitted with sensors or markers 207 along various parts the person's body and the article of clothing 205 is fitted with sensors or markers 206 at various locations. The locations for the sensors 206, 207 are selected such that as the person moves, the movement of various parts of articles of clothing relative to select part of the person can be captured for modeling purposes. This type of movement is also referred to herein as motion flow. A camera 202 captures information pertaining to the sensors as the person moves in various directions, such as forwards 230, backwards 240, spinning around 220, sitting down 250 on a chair 203, and standing up 260. Although a system employing sensors on an article of clothing and on a person is shown, various techniques may be used which do not employ such sensors. For example, a combination of an infrared or heat sensing system, with a standard or three-dimensional camera that captures visible light could be used to collect the necessary data, such as by comparing or combining information derived from the visible light system with the infrared/heat sensing system. One popular system that may be adapted for this purpose is the Kinect® system sold by the Microsoft Corporation. Other systems may employ x-rays or millimeter waves or other similar technology to see through clothing to obtain body characteristics. Statistical analysis based on collecting information from the various models is preferably used to create a set of modeling parameters for the clothing line. The modeling parameters may be represented as data, or algorithmically.

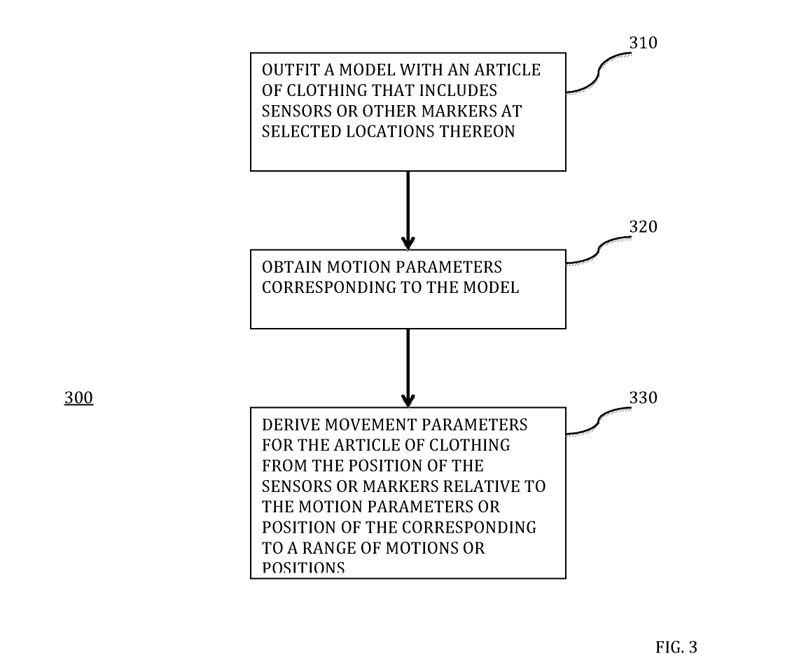

FIG. 3 summarizes a procedure for capturing movement parameters, in accordance with the present invention. Preferably, models are selected with a range of sizes and body shapes suitable for characterizing a clothing line. A person or model is outfitted with an article of clothing that includes sensors or other markers at selected locations on the clothing, step 310. Motion parameters are obtained when the model moves to cover patterns of typical motion such as walking, sitting, standing and turning around, step 320. Movement and/or position parameters of the article of clothing are derived from the position of the sensors or markers relative to the motion parameters of the model corresponding to a range of motions or positions, step 330. While the preferred embodiment employs sensors or markers, various alternatives are contemplated. For example, a system that employs two-dimensional or three-dimensional image capture and processing could be used to generate movement parameters for the article of clothing. Thermal sensing or infrared cameras may also be used to capture a person's motion or the movement of clothing on a person in motion, as well as other modeling parameters such as size and fit of clothing worn by a person.

In an example of computer based shopping session according to the present invention, the computer has access to a database of modeling parameters for an article of clothing, including movement parameters collected using methods outlined in the procedures described with respect to FIG. 3. The computer may also have access to a shopping related clothing profile of a person, including size, dimensions, fit and/or wear preferences, as well as style and vendor preferences. Wear preferences or characteristics refer how an article of clothing fits and moves on or with a person as the person undergoes a range of motion. Preferably, the computer has access to motion parameters characterizing how the person moves in accordance with a modeling pattern. A person's motion parameters may be captured using techniques similar to that described in FIGS. 2 and 3, or may be obtained from a previous modeling session captured by the system or otherwise supplied from external sources.

In one embodiment of a shopping session, the system obtains search parameters for a person for matching articles of clothing to the persons fit and wear criteria. The search parameters may be derived from stored information, such as style, fit, wear, and vendor preferences, previously stored as the person's profile, or may be derived in real-time, such as through a live camera session where size, fit, motion parameters are determined, or may be some combination of previously stored and real-time information. The system uses the search parameters to access a database to obtain parameters for various articles of clothing including fit and wear characteristics, and movement parameters for the clothing that meet the search criteria. The movement parameters for the article of clothing may be based in part on the size parameters for the article of clothing and the size parameters for the person. The system then presents each article of clothing by generating motion representation for the person, and then by manipulating a representation of the article of clothing on a representation of the person in motion using the movement parameters for the article of clothing. In one embodiment, manipulating the representation of the article of clothing includes capturing a motion image of the person in motion, mapping the movement parameters of the article of clothing to motion image of the person, and displaying an image of the person in motion augmented with the article of clothing such as to appear to an observer that the person in motion is wearing the article of clothing. Similarly, the image of the person in motion may be generated algorithmically, or using a sequence of motion images previously stored or generated in real-time. A computer system, such as the Kinect® system, with an attached or accessible camera and display system, preferably with a thermal imaging system, may be configured to capture a person in motion and superimpose the article of clothing on that person using the movement parameters for the article of clothing to highlight movement of article of clothing on the person. Note that the movement parameters for the article of clothing may also be used on a stationary image of a person.

The present invention contemplates the potential use of a data warehouse in the shopping experience. In this case, the user's data is stored in the data warehouse and is accessible by various vendors, and data use or distribution controlled in part by the user, such as by using an electronic key or password, or by setting up profile preferences. A clothing vendor may be given access to the data in order to determine matches, suggest purchases or for advertisement purposes. The user may have control over vendor access rights, and may be allowed to solicit matches from vendors anonymously. Data may be accessible for custom designs as specified by the user. In a typical shopping experience, the user may provide style information and preferred wear or fit characteristics, and obtain selections from the vendor base that represent a best match. A motion representation of the user is the presented that utilizes the movement parameters of the clothing, so as to present an image to the user of how the clothing fits and wears as the user goes through a range of motions (see FIG. 2). Upon receiving and physically wearing the article of clothing, the user may provide feedback using a camera or other motion capture system, and this feedback provided to the vendor. The user may elect to adjust preferences, or the vendor may fine tune movement parameters for the articles of clothing based on this feedback. A ranking system is contemplated for vendors based on this type of feedback.

The present invention contemplates the use of social media in the shopping experience. By having a database of modeling parameters, including motion parameters for a person through a range of motions, and by having corresponding access to modeling or wear parameters for articles of clothing, including movement parameters for the clothing as worn on a person in motion, both can be matched to create a virtual shopping or modeling experience. A person creates a clothing profile accessible to a social media network site, such as Facebook, Twitter, and the like. The person grants permission to access the profile to friends, and family members, or other interested third parties. The system suggests or these third parties otherwise select articles of clothing that might be suitable for person, using modeling parameters sourced from the database. The system uses an avatar or other representation of a person, such as a pre-recorded motion sequence, to model the article of clothing being worn on the representative person. Particularly, the system manipulates a representation of the article of clothing on a representation of the person in motion using the movement parameters for the article of clothing, to properly display fit and wear characteristics. Friends and other users of the social media network site vote on best fit, and provide suggestions to the person. The system may also be used to anonymously shop for others. This system is also configurable to request a best match from vendors based on the modeling parameters, and on feedback provided via the social network. Feedback sourced from the social network system, and comparisons of actual fit with model predicted fit, are used to further enhance the system, and to improve the modeling parameters stored for the clothing line and for the person.

What we claim:

1. A method for presenting articles of clothing for a person, comprising the steps of:
obtaining movement parameters for an article of clothing;
generating motion representation for the person; and
manipulating a representation of the article of clothing on a representation of the person in motion using the movement parameters for the article of clothing.

2. The method of claim 1, further comprising:
obtaining size parameters for an article of clothing;
obtaining size parameters for a person;
wherein the step of manipulating comprises the step of deriving movement parameters for the article of clothing based in part on the size parameters for the article of clothing and the size parameters for the person.

3. The method of claim 1, wherein the step of manipulating comprises the steps of:
capturing a motion image of the person in motion;
mapping the movement parameters of the article of clothing to the motion image of the person; and
displaying an image of the person in motion augmented with the article of clothing such as to create an appearance to an observer that the person in motion is wearing the article of clothing.

4. The method of claim 3, wherein the step of generating motion representation comprises the step of obtaining from a database an image sequence representing the person in motion.

5. The method of claim 1, further comprising using databases to get movement parameters for the person and clothing parameters with respect to a vendor to match articles of clothing that meet a fit and wear criteria.

6. The method of claim 1, wherein the step of obtaining movement parameters comprises the step of capturing images of a model wearing an article of clothing using an infrared or heat-sensing camera.

7. The method of claim 1, wherein the step of obtaining movement parameters comprises the step of capturing images of a model wearing an article of clothing and having sensors or markers on the model or article of clothing.

8. A method for presenting articles of clothing for a person, comprising the steps of, within an automated system:
storing a clothing profile for a person including style, fit and wear preferences;
obtaining representation for an article of clothing selected by comparing the clothing profile with clothing characteristics, including movement parameters, for articles of clothing selected from a plurality of clothing sources;
displaying a representation of the article of clothing on a representation of the person in motion using the movement parameters for the article of clothing;
obtaining feedback regarding fit and wear characteristics of the article of clothing on the person; and
ranking the plurality of clothing sources based on the feedback.

9. The method of claim 8, wherein the step of obtaining feedback comprises the step of using a camera to capture the person physically wearing the article of clothing.

10. The method of claim 8, further comprising the step of controlling access to the clothing profile based on a permissions system designed to selectively grant access to friends and vendors, with different access rights.

11. The method of claim 8, further comprising the step of providing access to the clothing profile to selected members of a social media network.

12. The method of claim 11, further comprising the step of obtaining suggestions for articles of clothing for the person directly through the social media network.

13. The method of claim 11, further comprising the step of using an avatar representation of the person to model the article of clothing being worn on the person through a predetermined range of motions.

14. The method of claim 13, further comprising the step of operating a voting system for capturing feedback with respect to the suitability of the article of clothing for the person based on the avatar representation.

15. The method of claim 12, wherein the step of obtaining representation comprises the step of requesting a best match from vendors based on the clothing profile and on suggestions from the members of the social media network.

16. The method of claim 12, further comprising the step of serving advertising to the person or selected members of the social media network based on the clothing profile and on inputs from the selected members of the social media network.

17. The method of claim 8, wherein the step of displaying comprises the steps of:
capturing a motion image of the person in motion;
mapping the movement parameters of the article of clothing to the motion image of the person; and
displaying an image of the person in motion augmented with the article of clothing such as to create an appearance to an observer that the person in motion is wearing the article of clothing.

18. The method of claim 8, wherein the step of obtaining representation for an article of clothing comprises the step obtaining movement parameters derived from capturing images of a model wearing an article of clothing while having sensors or markers on the model or article of clothing.

19. A virtual shopping system, comprising:
a database including representation of an article of clothing and associated movement parameters characterizing motion flow of the article of clothing on a person in motion;
a user interface system coupled to the database, and having access to a clothing profile for a person, the clothing profile including preferences for fit and wear characteristics for clothing, the using interface system comprising:
input means for selecting the article of clothing; and
an image generator configured to generate a representative image of the person in motion, and for manipulating the representative image of the person in motion using the movement parameters for the article of clothing such as to create an appearance to an observer that the person in motion is wearing the article of clothing; and
a display system configured to display the representation image of the person in motion wearing the article of clothing based on selection of the article of clothing.

20. The system of claim 19, wherein the user interface system further comprises an image capture system configured to capture a motion image of the person in motion, and wherein the image generator is configured to superimpose the article of clothing on the person in motion using the movement parameters.
